(19) United States
(12) Patent Application Publication
(10) Pub. No.: US 2024/0281266 A1
(43) Pub. Date: Aug. 22, 2024

(54) SCREEN CREATION DEVICE AND COMPUTER-READABLE STORAGE MEDIUM

(71) Applicant: Fanuc Corporation, Minamitsuru-gun, Yamanashi (JP)

(72) Inventors: Shinichi Ozeki, Minamitsuru-gun, Yamanashi (JP); Kouji Osada, Minamitsuru-gun, Yamanashi (JP)

(73) Assignee: Fanuc Corporation, Minamitsuru-gun, Yamanashi (JP)

(21) Appl. No.: 18/568,985

(22) PCT Filed: Jun. 23, 2021
(86) PCT No.: PCT/JP2021/023822

§ 371 Date: Dec. 11, 2023

(51) Int. Cl. G06F 9/451

(52) U.S. Cl. CPC G06F 9/451

(57) ABSTRACT

Provided is a screen creation device for assisting in creating a user interface screen of a numerical control device. The screen creation device includes a parts library that stores parts to be placed on the user interface screen and composite parts obtained by combining a plurality of parts. The screen creation device determines, with regard to a composite part to be placed on the user interface screen, whether or not the user interface screen includes a dependent composite part that is necessary for the composite part to function and, if the user interface screen does not include the dependent composite part, notifies a user of the absence of the dependent composite part.

### CROSS REFERENCE TO RELATED APPLICATIONS

This is the U.S. National Phase application of PCT/JP2021/023822, filed Jun. 23, 2021 the disclosures of this application being incorporated herein by reference in its entirety for all purposes.

### FIELD OF THE INVENTION

The present invention relates to a screen creation device and a computer-readable storage medium.

### BACKGROUND OF THE INVENTION

A numerical controller is a device for controlling a machine tool. The numerical controller is provided with a user interface screen (referred to as a UI screen). The UI screen displays a state of the machine tool and receives input by an operator. A creator of the UI screen creates the UI screen in accordance with a type of machine tool, a machine configuration of the machine tool, specifications required by a user, etc.

Different types of information may be displayed on one UI screen.

For example, Patent Document 1 includes FIG. 4 showing an editing screen, and represents that “a history data display region 111 for displaying a set of history data, a related part display region 112 for displaying a related part, etc. corresponding to each operation included in the history data, and a guidance screen display region 113 for displaying a guidance screen being created are included”. This editing screen is provided with a plurality of different types of display regions.

Dedicated software for creating the UI screen of the numerical controller is installed in a PC (personal computer) serving as a screen creation device. This software provides parts for screen creation. The user arranges these parts on the screen, sets properties (attributes and operation contents (execution functions)) of individual parts, and completes the UI screen.

### PATENT DOCUMENT

Patent Document 1: JP 2020-135820 A

### SUMMARY OF THE INVENTION

Parts of the UI screen may have dependencies. For example, some parts do not independently function. For example, to execute an operation button for moving a tool, an input part for inputting coordinates of a destination is required. Dependency of a part may be detected by debugging. However, when a problem is found in a downstream process, the UI screen need be recreated, which is cumbersome.

Techniques for simplifying creation of user interfaces are desirable in the field of numerical controllers.

A screen creation device which is an aspect of the present disclosure is a screen creation device for supporting creation of a user interface screen of a numerical controller, the screen creation device including a part library configured to store parts arranged on the user interface screen and a composite part obtained by combining a plurality of parts, a dependency determinator configured to determine whether or not a depended composite part required for the composite part arranged on the user interface screen to function is present on the user interface screen, and an editor configured to notify a user, when the depended composite part is not present on the user interface screen, as such.

A storage medium which is an aspect of the disclosure is a storage medium storing a computer-readable instruction, the storage medium storing parts arranged on a user interface screen and a composite part obtained by combining a plurality of parts, the instruction being executed by one or a plurality of processors to determine whether or not a depended composite part required for the composite part arranged on the user interface screen to function is present on the user interface screen, and notify a user of, when the depended composite part required for the composite part arranged on the user interface screen to function is not present on the user interface screen, as such.

According to one aspect of the invention, it is possible to simplify creation of a user interface.

### BRIEF DESCRIPTION OF DRAWINGS

FIG. 1 is a diagram illustrating a relationship between a screen creation device and a numerical controller;

FIG. 2 is a block diagram of a screen creation device of the first disclosure;

FIG. 3 is an example of a UI editing screen;

FIG. 4 is a diagram illustrating a relationship between a composite part and single parts;

FIG. 5 is a diagram showing an example of a UI screen on which composite parts are arranged;

FIG. 6 is a diagram showing an example of a composite part having dependency;

FIG. 7 is a diagram showing an example of a dependency table of the first disclosure;

FIG. 8 is a flowchart for illustrating an operation of a screen creation device of the first disclosure;

FIG. 9 is a diagram showing an example of a screen on which a depending composite part and a depended composite part are arranged;

FIG. 10 is a flowchart for illustrating processing when a composite part is deleted from a UI editing region;

FIG. 11 is a block diagram of a screen creation device of the second disclosure;

FIG. 12 is a diagram showing an example of machine information;

FIG. 13 is a diagram showing an example of a dependency table of the second disclosure; and

FIG. 14 is a diagram illustrating a hardware configuration of the screen creation device.

### First Disclosure

Hereinafter, a screen creation device 100 of the first disclosure will be described.

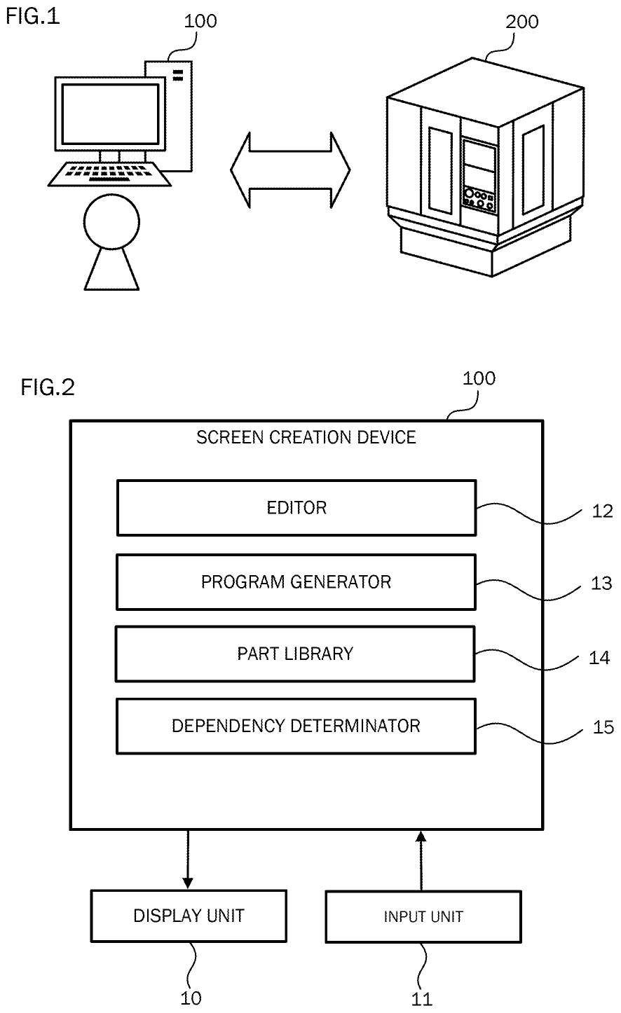

As illustrated in FIG. 1, the screen creation device 100 is installed in an information processing device such as a PC (personal computer). Dedicated software for creating an operation screen of a numerical controller 200 is installed in the screen creation device 100. A user operates the software to create a UI screen. The created UI screen is transferred to the numerical controller 200 and installed in the numerical controller 200.

FIG. 2 is a block diagram of the screen creation device 100 of the first disclosure. The screen creation device 100 includes a display unit 10, an input unit 11, an editor 12, a program generator 13, a part library 14 and a dependency determinator 15.

The editor 12 displays a UI editing screen 20 on the display unit 10 of the screen creation device 100, and receives operation input for screen editing by the user. The editor 12 updates layout of the screen and properties (attributes) of parts according to operation input of the user, and reflects the update on the UI editing screen 20.

The program generator 13 converts the properties of the parts and layout of the UI screen created by the editor 12 into an executable program. The executable program is implemented in the numerical controller 200 and function as the UI screen.

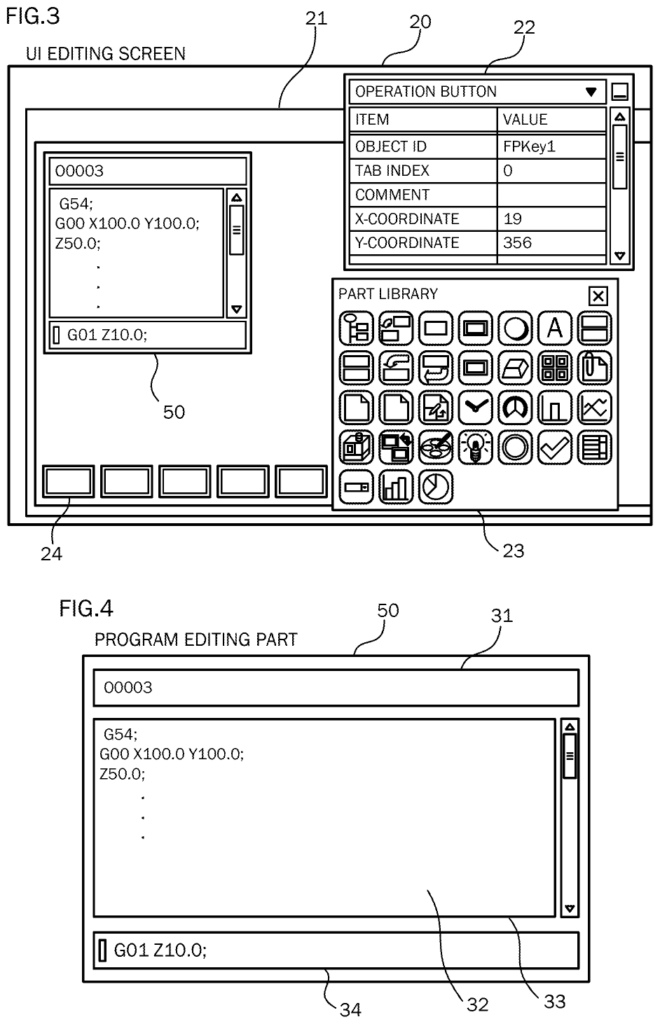

FIG. 3 exemplifies the UI editing screen 20. The UI editing screen 20 includes a UI editing region 21, a property display region 22, and a part library display region 23. Parts arranged on the UI editing screen 20 are displayed in the part library display region 23. In FIG. 3, five parts (operation buttons 24) are arranged on the UI editing screen 20. One of the five operation buttons 24 is selected. Properties of the selected operation button 24 are displayed in the property display region 22.

In the property display region 22, visual information such as a size, a shape, or a display position of a part, a label such as a numerical value, an icon, or a letter string, a type of the part, a name of the part, operation content (an execution function) of the part, et cetera, can be set.

Parts in the part library 14 include a single part and a composite part 50. The single part indicates a stand-alone component. The single part includes the operation button 24, a key input button, a label, et cetera, however, is not limited thereto.

The composite part 50 indicates a part obtained by combining a plurality of single parts.

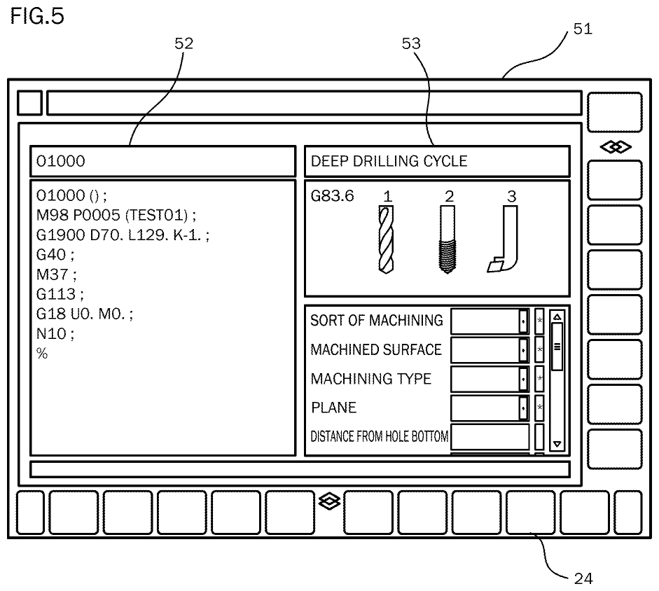

The composite part 50 (program editing part 52) in FIG. 4 includes a plurality of single parts (a label display part 31, a figure display part 32, a multi-line letter string display part 33, and an input reception part 34). The label display part 31 is a part for displaying a letter string. Here, a program name “00003” is displayed. The figure display part 32 is a part used for screen design. Here, it is a blue background. The multi-line letter string display part 33 is a part for displaying a plurality of letter strings. Here, a machining program is displayed in the multi-line letter string display part 33. The input reception part 34 receives input of a letter string to be edited. By pressing an “Enter” key, a letter string which is input to the input reception part 34 is reflected in the multi-line letter string display part 33.

With reference to FIG. 5, a UI screen on which composite parts 50 are arranged will be described. A base part 51 and the composite parts 50 are arranged in a UI editing region 21 in FIG. 5. As illustrated in FIG. 5, operation buttons 24 for operating the UI screen are arranged in a region of a lower portion and a right portion of the base component 51. Composite part 50 and single parts can be arranged in a central region of the base part 51.

Two composite parts 50 (a program editing part 52 and a G-code guidance part 53) are arranged in the base part 51 in FIG. 5.

The program editing part 52 displays a machining program, and receives editing of the machining program. The G-code guidance part 53 displays a description of G-code or receives setting of arguments of G-code with respect to G-code displayed in the program editing part 52. In the G-code guidance part 53 in FIG. 5, an input region for inputting a name of G-code “deep drilling cycle”, an illustration describing a G-code number and an input item, and an argument of G-code is provided.

The G-code guidance part 53 and the program editing part 52 have dependency. When the program editing part 52 is not arranged on the UI screen, the G-code guidance part 53 does not function. A composite part 50 that depends on another composite part 50 is expressed as “depending composite part”, whereas a composite part 50 depended upon is expressed as “depended composite part”.

Another example of the composite part 50 having dependency will be described.

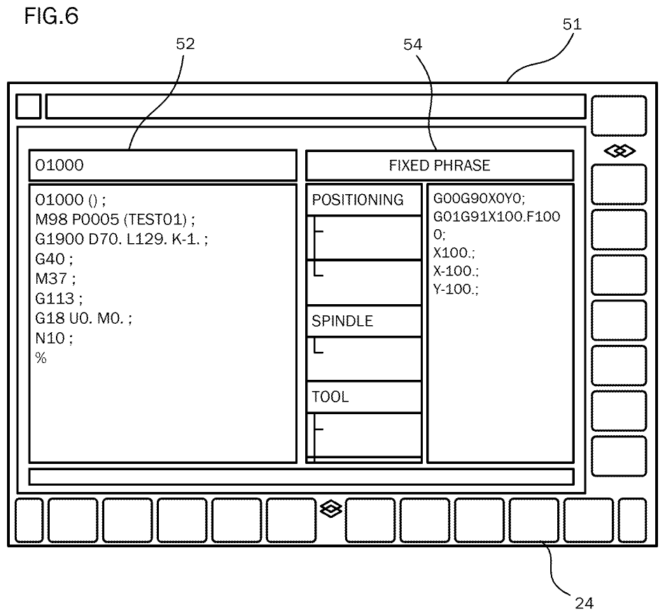

In the UI editing region 21 in FIG. 6, two composite parts 50, that is, a program editing part 52 and a fixed phrase part 54, are arranged. The program editing part 52 receives editing of the machining program. The fixed phrase part 54 registers a fixed phrase and inserts the registered processing program.

The fixed phrase part 54 and the program editing part 52 have a depending and depended relationship. In other words, when the program editing part 52 is not arranged on the UI screen, the fixed phrase part 54 does not function.

The dependency determinator 15 determines whether or not the composite part 50 arranged in the UI editing region 21 is a depending composite part. When the composite part 50 arranged in the UI editing region 21 is the depending composite part, the dependency determinator 15 determines whether or not a composite part 50 (referred to as a depended composite part) on which this composite part 50 depends is present on the UI screen.

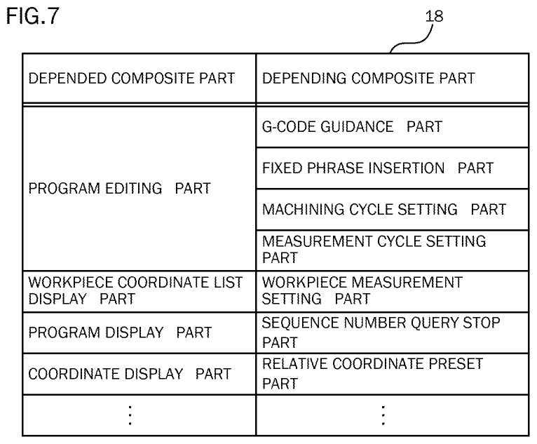

Information related to dependency of the composite part 50 is recorded in a dependency table 18 shown in FIG. 7. The dependency table 18 has items of “depended composite part” and “depending composite part”. A “depending composite part” does not function without a “depended composite part”.

Dependency of the composite part 50 can be seen with reference to the dependency table 18. In the example of FIG. 7, the G-code guidance part 53, the fixed phrase part 54, a machining cycle setting part, and a measurement cycle setting part depend on the program editing part 52. A workpiece measurement setting part depends on a workpiece coordinate list display part. A sequence number query stop part depends on a program display part. A relative coordinate preset part depends on a coordinate display part.

The dependency determinator 15 determines whether or not the composite part 50 arranged in the UI editing region 21 depends on another composite part 50. When the composite part 50 arranged in the UI editing region 21 depends on another composite part 50 (depended composite part), the dependency determinator 15 determines whether or not the depended composite part is arranged in the UI editing region 21. When the depended composite part is not arranged in the UI editing region 21, the user is notified of this information. A notification method includes warning display, message display, icon display, etc. However, the notification method is not limited thereto.

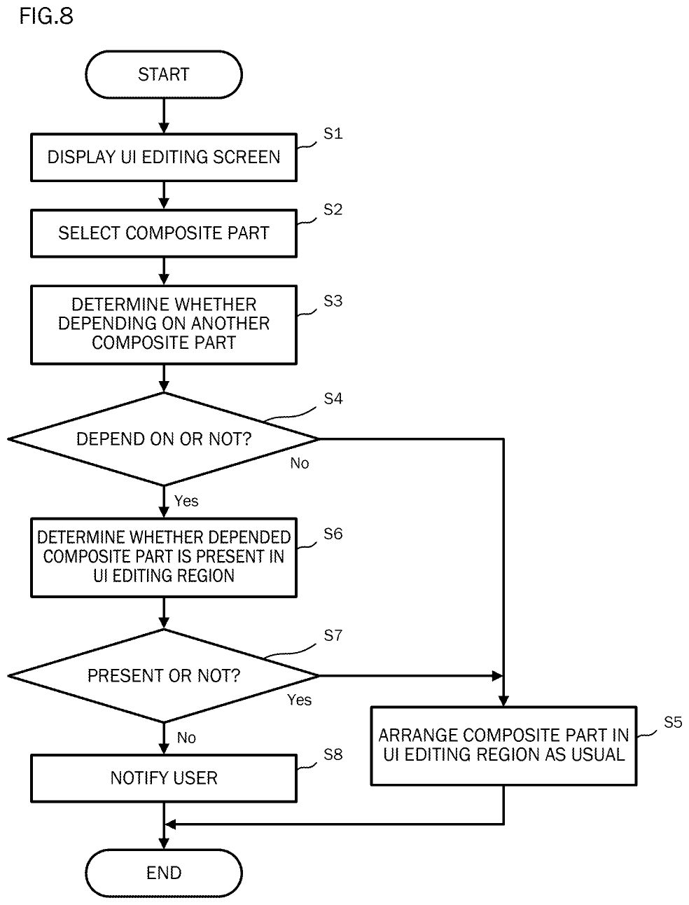

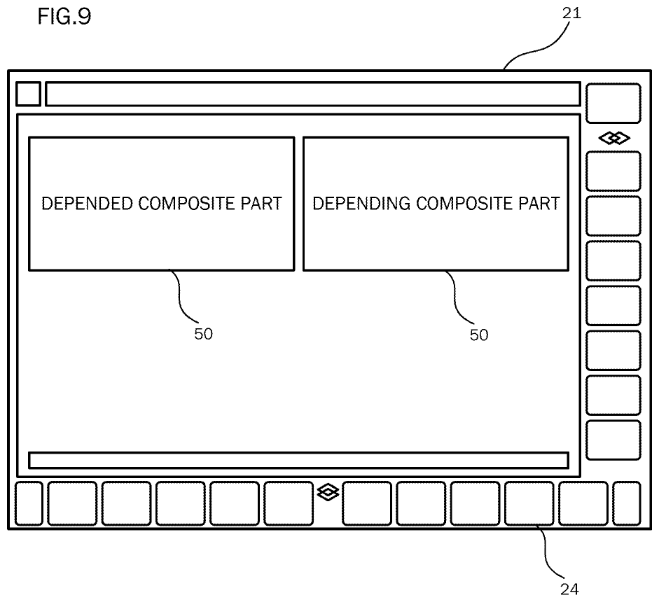

Processing by the screen creation device 100 of the first disclosure will be described with reference to a flowchart of FIG. 8. The screen creation device 100 displays the UI editing screen 20 (step S1). On the UI editing screen 20, a composite part 50 can be selected from the part library display region 23.

When a composite part 50 is selected from the part library display region 23 (step S2), the dependency determinator 15 determines whether or not the selected composite part 50 depends on another composite part 50 (step S3). When the selected composite part 50 does not depend on another composite part 50 (step S4; No), the editor 12 arranges the composite part 50 in the UI editing region 21 as usual (step S5).

When the selected composite part 50 depends on another composite part 50 (depended composite part) (step S4; Yes), the dependency determinator 15 determines whether or not the depended composite part is present in the UI editing region 21 (step S6). When the depended composite part is present in the UI editing region 21 (step S7; Yes), the editor 12 arranges composite part 50 in the UI editing region 21 as usual (step S5).

When the depended composite part is not arranged in the UI editing region 21 (step S7; No), the editor 12 notifies the user with warning display, message display, icon display, etc. (step S8).

The dependency determinator 15 determines dependency when deleting the composite part 50 from the UI editing region 21.

FIG. 9 is a screen on which both the depending composite part and the depended composite part are arranged. Here, when the user gives a command to delete the composite part 50 from the screen, the dependency determinator 15 determines whether or not the composite part 50 to be deleted is a depended composite part. When the composite part 50 to be deleted is a depended composite part, the dependency determinator 15 determines whether or not a composite part 50 depending on the composite part 50 to be deleted is present. When no composite part 50 depending on the depended composite part in the UI editing region 21 is present, the editor 12 allows deletion of the depended composite part from the UI editing region 21. When a composite part 50 depending on the depended part is present in the UI editing region 21, the editor 12 notifies the user using warning display, message display, icon display, etc.

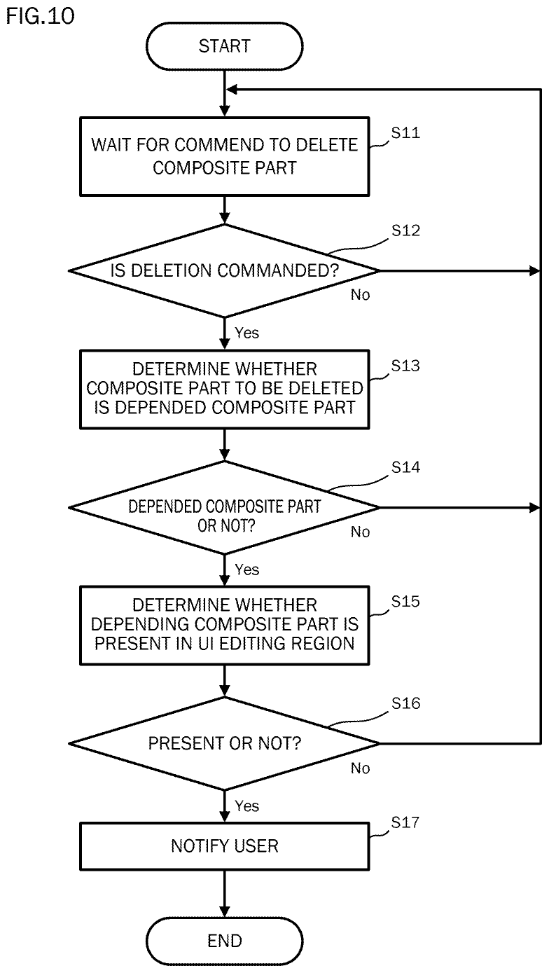

Processing of deleting the composite part 50 from the UI editing region 21 will be described with reference to a flowchart in FIG. 10. It is assumed that the composite part 50 is arranged in the UI editing region 21. The editor 12 waits for a command to delete the composite part 50 arranged in the UI editing region 21 (step S11). Deletion of the arranged composite part 50 is commanded (step S12; Yes). The dependency determinator 15 determines whether or not the composite part 50 to be deleted is a depended part (step S13). When the composite part 50 to be deleted is a depended composite part (step S14; Yes), the dependency determinator 15 determines whether or not a depending composite part of the composite part 50 to be deleted is present in the UI editing region 21 (step S15). When the depended composite part of the composite part 50 to be deleted is present in the UI editing region 21 (step S16; Yes), the editor 12 notifies the user with warning display, message display, icon display, etc. (step S17).

When no command to delete the composite part 50 is given (step S12; No), the composite part 50 to be deleted is not a depended composite part (step S14; No), or the composite part 50 depending on the composite part to be deleted is not present in the UI editing region 21 (step S16; No), the editor 12 does not perform any specific processing, and proceeds to step S11 to wait for a command of the user.

As described above, the screen creation device 100 of the first disclosure stores dependency of the composite part 50. When a depending composite part is arranged in the UI editing region 21 where a depended composite part is not present, the creation device 100 displays a warning or a message to notify the user of the UI screen.

In a single part, a purpose of use of an individual part is unknown, and thus it is difficult to identify dependency in advance. The composite part 50 is created for a specific purpose of use, and thus dependency can be identified. Dependency of a part may be detected by debugging. However, when a problem is found in a downstream process, the UI screen comes to be recreated. In the screen creation device 100 of the present disclosure, because dependency can be identified at the time of arranging the composite part 50, dependency can be confirmed in advance. Thus, labor of correction is reduced, and creation of the UI screen can be simplified.

### Second Disclosure

Hereinafter, a screen creation device 100 of the second disclosure will be described.

In the screen creation device 100 of the second disclosure, machine information of the machine tool, which is a control target of the numerical controller 200, is used to determine dependency of a composite part 50. Since the screen creation device 100 of the first disclosure and the screen creation device 100 of the second disclosure have similar components, only differences from the first screen creation device 100 will be described.

FIG. 11 is a block diagram of the screen creation device 100 of the second disclosure. The screen creation device 100 of the second disclosure includes a machine information acquirer 16.

The machine information acquirer 16 acquires machine information of the machine tool. The machine information may be directly input to the screen creation device 100 or may be extracted from parameters or option information set in the numerical controller 200.

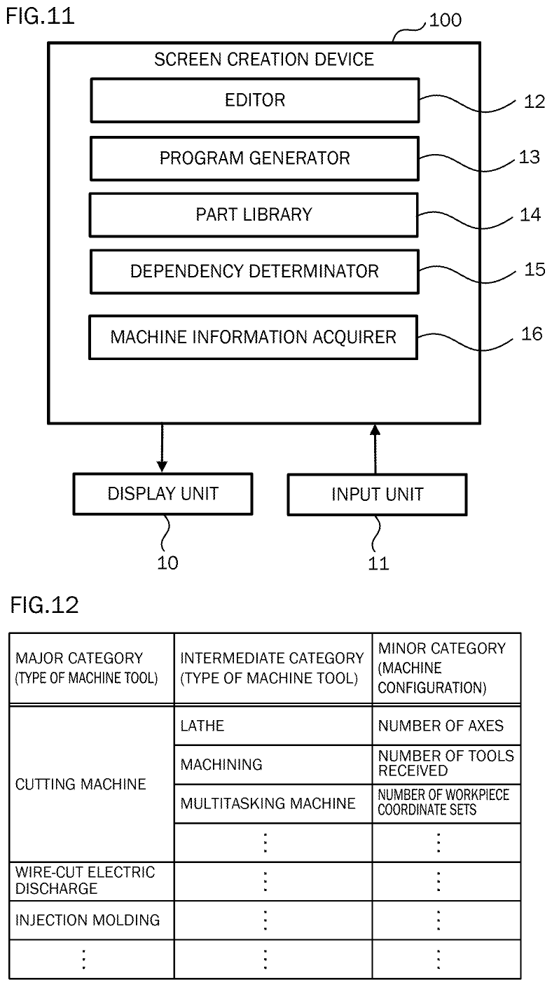

The machine information is information related to the machine tool, such as a type and a machine configuration of the machine tool. FIG. 12 exemplifies an example of the machine information. The table in FIG. 12 has items of “major category”, “intermediate category”, and “minor category”. The “major category” is a category according to a type of machine tool. The “major category” in FIG. 12 has items such as “cutting machine”, “wire-cut electric discharge machine”, and “injection molding”. The “intermediate category” is a category according to a type of machine tool, and is a more subdivided category than the “major category”. The major category “cutting machine” in FIG. 12 is subdivided into items such as intermediate categories “lathe”, “machining”, and “multitasking machine”. The “minor category” is a category obtained by subdividing an intermediate category according to a machine configuration. The “intermediate category” in FIG. 12 is divided into “minor categories” such as “number of axes”, “number of tools stored”, and “number of workpiece coordinate sets”.

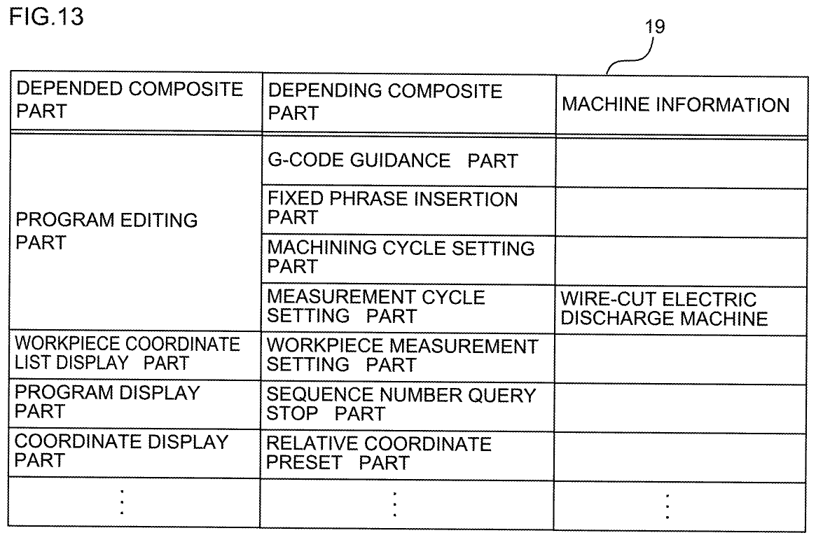

A dependency table 19 of the second disclosure includes machine information. The dependency table 19 in FIG. 13 has items of “depended composite part”, “depending composite part”, and “machine information”. Information related to an exceptional machine not having dependency is recorded in the item “machine information”. In the example of FIG. 13, when the machine tool being a control target is a wire-cut electric discharge machine, no dependency is established between the “program editing part 52” and the “measurement cycle setting part”.

In FIG. 13, depending composite parts depending on the “program editing part 52” are “G-code guidance part 53”, “fixed phrase part 54”, “machining cycle setting part”, and “measurement cycle setting part”. In most machine tools, dependency shown in FIG. 13 is established. However, in “wire-cut electric discharge machine”, since there is no tool, the dependency is not established between “program editing part 52” and “measurement cycle setting part”. In this way, dependency of the composite part 50 can be determined from the “machine information”.

The above example is an example in which machine information affects dependency in the “major category”. However, machine information in the “intermediate category” or the “minor category” may affect dependency of the composite part 50.

The dependency determinator 15 in the second disclosure determines dependency based on not only the “type of machine” but also the “machine information” when arranging or deleting the composite part 50. The editor 12 notifies the user with warning display, message display, icon display, et cetera, only when the dependency is not established by the “machine information”.

### [Hardware Configuration]

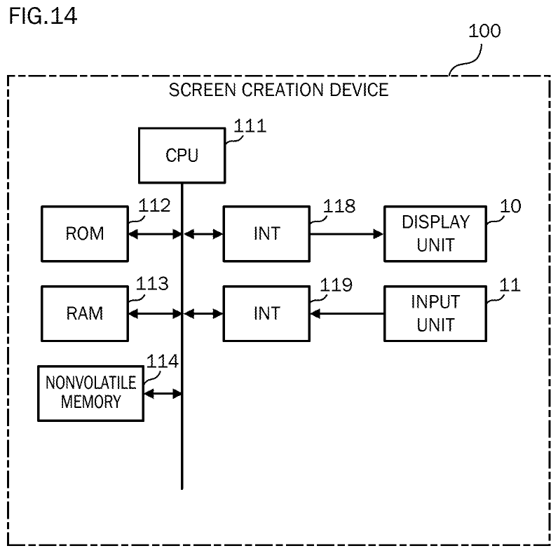

The screen creation device 100 of the disclosure has a hardware configuration illustrated in FIG. 14.

The hardware configuration of the screen creation device 100 will be described with reference to FIG. 14. A CPU 111 included in the screen creation device 100 is a processor for controlling the entire screen creation device 100. The CPU 111 reads a system program processed in a ROM 112 via a bus and controls the entire screen creation device 100 according to the system program. Temporary calculation data and display data, various data input by the user via an input unit 11, et cetera, are temporarily stored in a RAM 113.

A display unit 10 is, for example, a monitor attached to the screen creation device 100. The display unit 10 displays an operation screen, a setting screen, et cetera, of the screen creation device 100.

The input unit 11 is a keyboard, a touch panel, or the like, which is integrated with or separate from the display unit 10. The user operates the input unit 11 to perform input to a screen displayed on the display unit 10, and other matters. Note that the display unit 10 and the input unit 11 may be a mobile terminal.

As an example, a nonvolatile memory 114 is a memory that is backed up or the like by a battery, not shown, so that a storage state is retained even when the power of the screen creation device 100 is turned off. In the nonvolatile memory 114, a program read from an external device via an interface, not shown, a program input via the input unit 11, and various data acquired from each unit of the screen creation device 100, a machine tool, or the like (for example, a setting parameter acquired from the machine tool, and other data) are stored. The program and the various data stored in the nonvolatile memory 114 may be loaded in the RAM 113 during execution/use. In addition, various system programs are written to the ROM 112 in advance.

### EXPLANATIONS OF REFERENCE NUMERALS

100 SCREEN CREATION DEVICE
200 NUMERICAL CONTROLLER
10 DISPLAY UNIT
11 INPUT UNIT
12 EDITOR
13 PROGRAM GENERATOR
14 PART LIBRARY
15 DEPENDENCY DETERMINATOR
16 MACHINE INFORMATION ACQUIRER
18 DEPENDENCY TABLE
19 DEPENDENCY TABLE
50 COMPOSITE PART
111 CPU
112 ROM
113 RAM
114 NONVOLATILE MEMORY

1. A screen creation device for supporting creation of a user interface screen of a numerical controller, the screen creation device comprising:
a part library configured to store parts arranged on the user interface screen and a composite part obtained by combining a plurality of the parts;
a dependency determinator configured to determine whether or not a depended composite part required for the composite part arranged on the user interface screen to function is present on the user interface screen; and
an editor configured to notify a user of, when the depended composite part is not present on the user interface screen, as such.

2. The screen creation device according to claim 1, further comprising a machine information acquirer configured to acquire machine information of a machine tool serving as a control target of the numerical controller, wherein:
the dependency determinator determines whether or not dependency is established in a composite part arranged on a user interface screen for operating the machine tool based on the machine information of the machine tool; and
the editor notifies the user that, when the dependency is established, the depended composite part required for the composite part to function is not present on the user interface screen.

3. The screen creation device according to claim 1, wherein the editor notifies the user that the depended composite part required for the composite part to function is not present on the user interface screen using at least one of warning display, message display, or icon display.

4. The screen creation device according to claim 2, wherein the machine information includes at least one of a type of machine or a machine configuration.

5. A storage medium storing a computer-readable instruction, the storage medium storing parts arranged on a user interface screen and a composite part obtained by combining a plurality of the parts, the instruction being executed by one or a plurality of processors to:
determine whether or not a depended composite part required for the composite part arranged on the user interface screen to function is present on the user interface screen; and
notify a user of, when the depended composite part required for the composite part arranged on the user interface screen to function is not present on the user interface screen, as such.
